(19) United States
(12) Patent Application Publication
(10) Pub. No.: US 2018/0191785 A1
(43) Pub. Date: Jul. 5, 2018

(54) METHOD AND DEVICE FOR MAKING SECURE CALL IN MULTI-PARTY CALL, AND MULTI-PASS TERMINAL

(71) Applicant: SPREADTRUM COMMUNICATIONS (SHANGHAI) CO., LTD., Zhangjiang (CN)

(72) Inventors: Xichun GAO, Zhangjiang (CN); Xia WEI, Zhangjiang (CN); Erling WEI, Zhangjiang (CN)

(21) Appl. No.: 15/822,640

(22) Filed: Nov. 27, 2017

(30) Foreign Application Priority Data
Dec. 30, 2016 (CN) 201611254480.X

(51) Int. Cl. H04L 29/06; H04M 3/56

(52) U.S. Cl. CPC H04L 63/308; H04L 63/061; H04M 3/56; H04L 65/403

(57) ABSTRACT

Method and device for making a secure call in a multi-party call, and a multi-pass terminal are provided. The method includes: setting up a secure service data channel with terminals participating the secure call; and processing service data of the terminals participating the secure call which is transmitted on the secure service data channel. By embodiments of the present disclosure, the secure call may be set up and content of the secure call may be encrypted, so as to guarantee call security in the multi-party call.

### CROSS-REFERENCE TO RELATED APPLICATIONS

The present invention claims priority under 35 U.S.C. §119 to Chinese patent application No. 201611254480.X, filed on Dec. 30, 2016, and the entire disclosure of which is incorporated herein by reference.

### TECHNICAL FIELD

The present disclosure generally relates to communication technology field, and more particularly, to method and device for making a secure call in a multi-party call, and a multi-pass terminal.

### BACKGROUND

With the development of communication technology, functions and application fields of communication terminals become more and more. Specifically, besides basic applications deployed by operators, some government agencies or military agencies also have demands on multi-party call service. For example, in a multi-party conference, or in multi-person intercom service for special activities, security issues of the multi-party call become much more important.

During a multi-party call, some call content does not expect to be heard by everyone. In existing techniques, one or some of participants in the multi-party call can make a private call so that other participants cannot hear the content of the private call. However, if a private call participant operates incorrectly, the content of the private call may be heard by other participants in the multi-party call, and thus the security of the call cannot be guaranteed.

### SUMMARY

In embodiments of the present disclosure, method and device for making a secure call in a multi-party call, and a multi-pass terminal are provided. A secure call may be made, and content of the secure call may be encrypted, so as to guarantee security of the multi-party call.

In an embodiment of the present disclosure, a method for making a secure call in a multi-party call is provided, including: setting up a secure service data channel with terminals participating the secure call; and processing service data of the terminals participating the secure call which is transmitted on the secure service data channel.

Optionally, prior to setting up a secure service data channel with terminals participating the secure call, the method may further include: agreeing security types supported by the terminals participating the secure call.

Optionally, prior to setting up a secure service data channel with terminals participating the secure call, the method may further include: informing the terminals participating the secure call to use an agreed key.

Optionally, processing service data of the terminals participating the secure call which is transmitted on the secure service data channel may include: encrypting service data of the terminals participating the secure call which is transmitted on the secure service data channel; and decrypting service data of the terminals participating the secure call which is transmitted on the secure service data channel

Optionally, processing service data of the terminals participating the secure call which is transmitted on the secure service data channel may include: receiving first encrypted service data from the terminals participating the secure call; decrypting the first encrypted service data to obtain decrypted service data of the terminals participating the secure call; and performing audio mixing to the decrypted service data of the terminals participating the secure call except a first participant terminal, wherein the first participant terminal is any one of the terminals participating the secure call.

Optionally, processing service data of the terminals participating the secure call which is transmitted on the secure service data channel may include: encrypting the service data which has been subjected to the audio mixing to obtain second encrypted service data; and transmitting the second encrypted service data to the first participant terminal.

Optionally, setting up a secure service data channel with terminals participating the secure call may include: during a set-up process of the multi-party call, directly setting up the secure service data channel with the terminals participating the secure call.

Optionally, setting up a secure service data channel with terminals participating the secure call may include: during an unencrypted multi-party call, setting up the secure service data channel with the terminals participating the secure call outside a current unencrypted service data channel.

Optionally, the method may further include: transmitting unencrypted data from terminals which do not participate the secure call to the terminals participating the secure call via the unencrypted service data channel.

In an embodiment of the present disclosure, a device for making a secure call in a multi-party call is provided, including: a setting up circuitry configured to set up a secure service data channel with terminals participating the secure call; and a processing circuitry configured to process service data of the terminals participating the secure call which is transmitted on the secure service data channel.

Optionally, the device may further include an agreeing circuitry configured to: before the setting up circuitry sets up the secure service data channel with the terminals participating the secure call, agree security types supported by the terminals participating the secure call.

Optionally, the device may further include an informing circuitry configured to: before the setting up circuitry sets up the secure service data channel with the terminals participating the secure call, inform the terminals participating the secure call to use an agreed key.

Optionally, the processing circuitry may be configured to: encrypt service data of the terminals participating the secure call which is transmitted on the secure service data channel; and decrypt service data of the terminals participating the secure call which is transmitted on the secure service data channel.

Optionally, the processing circuitry may include: a receiving sub-circuitry configured to receive first encrypted service data from the terminals participating the secure call; a decrypting sub-circuitry configured to decrypt the first encrypted service data to obtain decrypted service data of the terminals participating the secure call; and an audio mixing sub-circuitry configured to perform audio mixing to the decrypted service data of the terminals participating the secure call except a first participant terminal, wherein the first participant terminal is any one of the terminals participating the secure call.

Optionally, the processing circuitry may further include: an encrypting sub-circuitry configured to encrypt the service data which has been subjected to the audio mixing by the audio mixing sub-circuitry to obtain second encrypted service data; and a transmitting sub-circuitry configured to transmit the second encrypted service data to the first participant terminal.

Optionally, the setting up circuitry may be configured to: during a set-up process of the multi-party call, directly set up the secure service data channel with the terminals participating the secure call.

Optionally, the setting up circuitry may be configured to: during an unencrypted multi-party call, set up the secure service data channel with the terminals participating the secure call outside a current unencrypted service data channel.

Optionally, the device may further include a transmitting circuitry configured to transmit unencrypted data from terminals which do not participate the secure call to the terminals participating the secure call via the unencrypted service data channel.

In an embodiment of the present disclosure, a multi-pass terminal including the above device for making a secure call in a multi-party call is provided.

Embodiments of the present disclosure provide method and device for making a secure call in a multi-party call, and a multi-pass terminal. By setting up the secure service data channel with the terminals participating the secure call, content of the secure call is transmitted after encryption, so as to realize call security among the terminals participating the secure call. Compared with the existing techniques, in embodiments of the present disclosure, the secure call may be set up and content of the secure call may be encrypted, so as to guarantee call security in the multi-party call.

### BRIEF DESCRIPTION OF THE DRAWINGS

FIG. 1 schematically illustrates a flow chart of a method for making a secure call in a multi-party call according to an embodiment;

FIG. 2 schematically illustrates a flow chart of a method for making a secure call in a multi-party call according to an embodiment;

FIG. 3 schematically illustrates a diagram of making a secure call in a multi-party call according to an embodiment;

FIG. 4 schematically illustrates a diagram of making a secure call in a multi-party call according to an embodiment;

FIG. 5 schematically illustrates a diagram of making a secure call in a multi-party call according to an embodiment;

FIG. 6 schematically illustrates a structural diagram of a device for making a secure call in a multi-party call according to an embodiment;

FIG. 7 schematically illustrates a structural diagram of a device for making a secure call in a multi-party call according to an embodiment; and

FIG. 8 schematically illustrates a structural diagram of a processing circuitry in a device for making a secure call in a multi-party call according to an embodiment.

### DETAILED DESCRIPTION

In order to clarify the object, solutions and advantages of embodiments of the present disclosure, embodiments of present disclosure will be described clearly in detail in conjunction with accompanying drawings. Below embodiments are only a portion of embodiments of the present disclosure. Other embodiments obtained by those skilled in the art without creative efforts based on the below embodiments belong to scope of the present disclosure.

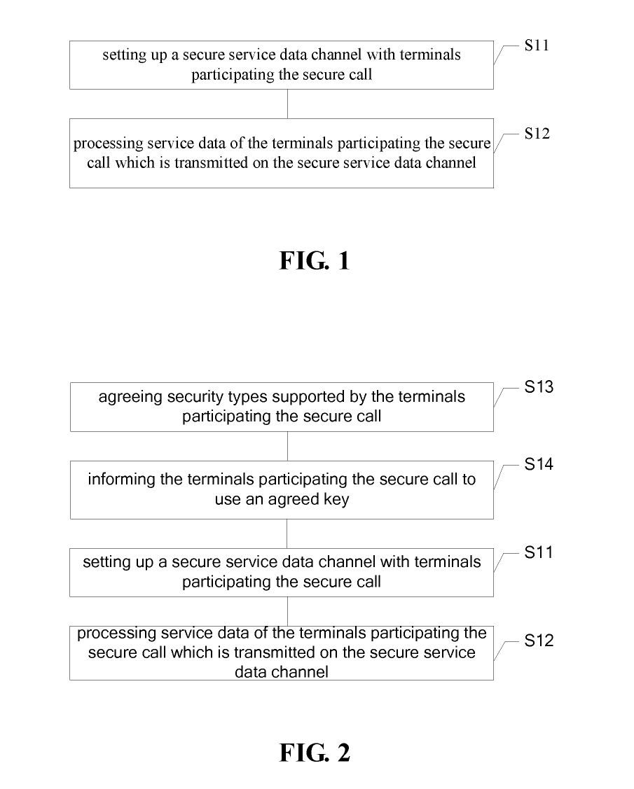

FIG. 1 schematically illustrates a flow chart of a method for making a secure call in a multi-party call according to an embodiment. Referring to FIG. 1, the method may include:

S11, setting up a secure service data channel with terminals participating the secure call; and

S12, processing service data of the terminals participating the secure call which is transmitted on the secure service data channel.

In some embodiments, referring to FIG. 2, prior to setting up a secure service data channel with terminals participating the secure call, the method may further include:

S13, agreeing security types supported by the terminals participating the secure call; and

S14, informing the terminals participating the secure call to use an agreed key.

The method provided in the embodiments of the present disclosure may realize an encrypted secure multi-party call, or setting up an encrypted secure call for a portion of terminals participating the multi-party call during an unencrypted multi-party call.

To describe the method more specifically, detailed examples are provided below.

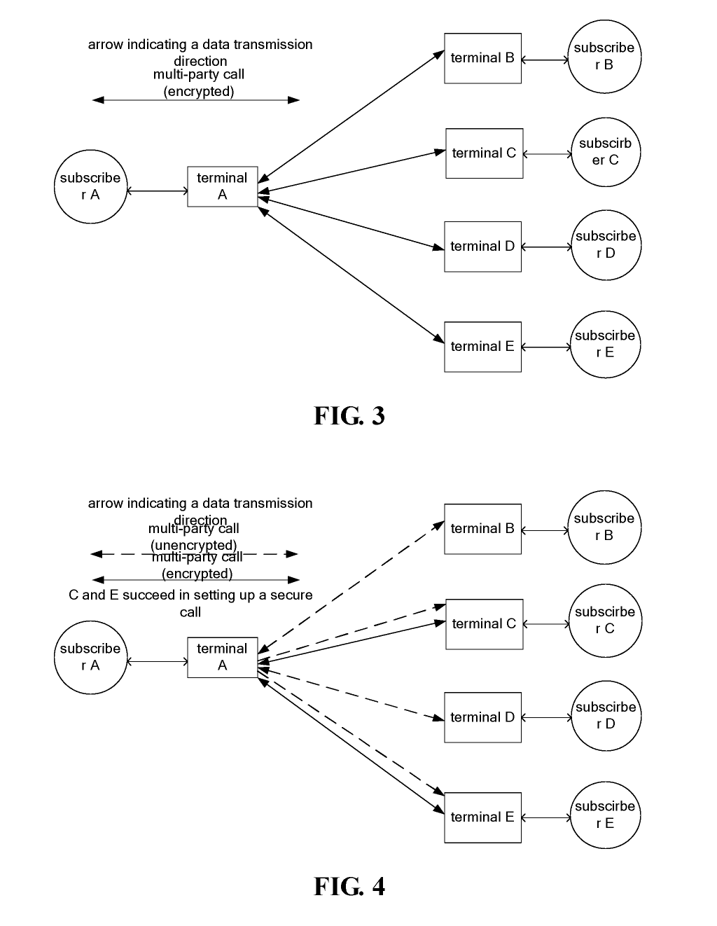

Referring to FIG. 3, in an embodiment, a diagram of setting up an encrypted secure multi-party call is illustrated. A process of setting up the encrypted secure multi-party call by a multi-pass terminal accompanies with a key validation process. The key validation process includes encryption of service data, decryption of service data, and audio mixing of service data. More specifically, the key validation process includes:

first, receiving first encrypted service data from the terminals participating the secure call;

second, decrypting the first encrypted service data to obtain decrypted service data of the terminals participating the secure call;

third, performing audio mixing to the decrypted service data of the terminals participating the secure call except a first participant terminal, wherein the first participant terminal is any one of the terminals participating the secure call;

fourth, encrypting the service data which has been subjected to the audio mixing to obtain second encrypted service data; and

fifth, transmitting the second encrypted service data to the first participant terminal.

The key validation process may be realized by various ways. In some embodiments, a multi-party call organizer (such as terminal A) agrees a key with participants of the multi-party call before a secure call is set up. For example, the multi-party call organizer A informs other multi-party call terminals B, C, D and E through short messages, emails or chat tools, so as to agree the key. During a call set-up process, the multi-party call organizer needs to inform the other participants to use the agreed key through signaling which includes private signaling or expanded IMS signaling. The multi-party call organizer may directly interact types of call during the call, through signaling which includes private signaling or expanded IMS signaling, to determine whether other participants support the call of a particular type, such as a specific secure call. If the other participants do not support the call of the particular type, it is failed to set up the call; or else, the set-up of the call is successful. After the secure call is set up, other terminals which do not support the secure call type cannot succeed in participating the call even if receiving an invitation.

Referring to FIG. 4, in an embodiment, a diagram of setting up a secure call between terminals C and E during an unencrypted multi-party call is illustrated. During the unencrypted multi-party call among the terminals A, B, C, D and E, a data forwarding channel is set up among the terminals A, C and E. Before the secure call is set up, the terminal A agrees a key with the terminals C and E. For example, the terminal A informs the terminals C and E through short messages, emails or chat tools, so as to agree the key. During a call set-up process, the multi-party call organizer (i.e., the terminal A) informs the other participants (i.e., the terminals C and E) to use the agreed key through signaling which includes private signaling or expanded IMS signaling.

After the secure call is set up among the terminals A, C and E, there are two data forwarding channels. Data of the terminal C and E will be transmitted on the new secure data forwarding channel, so that secure call content between the terminals C and E can be heard only by themselves, while other terminals A, B and D cannot hear it. For the terminals C and E, the previous data channel for receiving data from the terminal A is not changed, so that the terminals C and E still can hear call content of the terminals A, B and D.

It should be noted that, although call content between the terminals C and E passes the terminal A, the terminal A cannot decrypt the call content if unaware of the key used by the terminals C and E, as data between the terminals C and E is encrypted. Besides, during the set-up process of the secure call between the terminals C and E, it should be made sure that the terminal A is unaware of the key used.

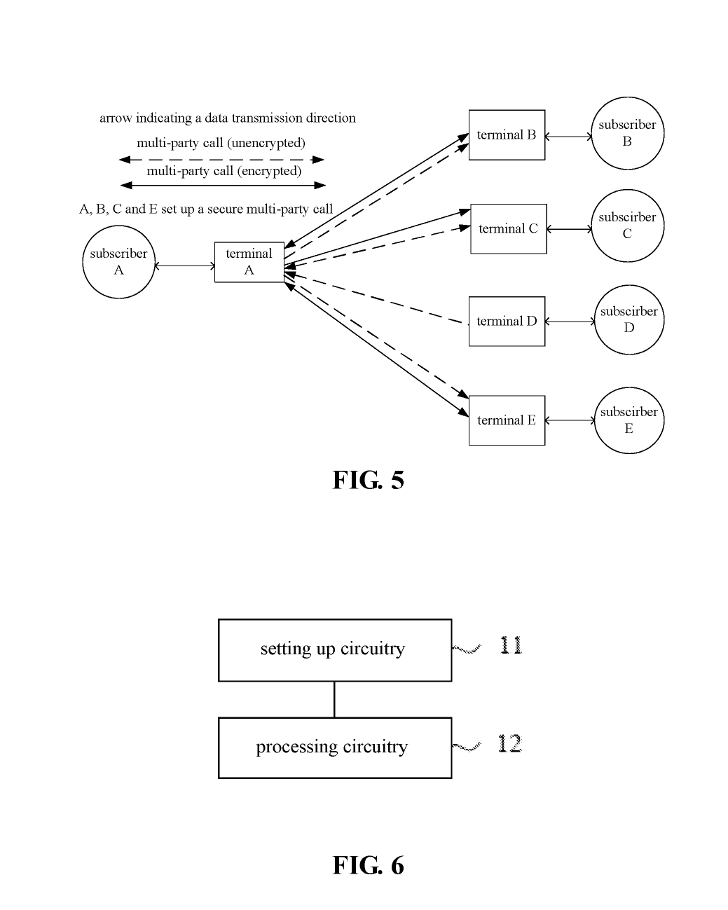

Referring to FIG. 5, in an embodiment, a diagram of setting up a secure call between terminals A, B, C and E during an unencrypted multi-party call is illustrated. The detailed process is similar with the above embodiment as shown in FIG. 4. After the secure call is set up, secure call content among the terminals A, B, C and E can be heard only by themselves, while other terminal D cannot hear it. As the participants of the unencrypted multi-party call, the terminals A, B, C and E still can hear talk content of the terminal D. It should be noted that, although call content among the terminals A, B, C and E passes the data forwarder, the data forwarder cannot decrypt the call content if unaware of the key used in the secure call, as data among the terminals A, B, C and E is encrypted. Besides, during the set-up process of the secure call, it should be made sure that the data forwarder is unaware of the key used if the data forwarder is not a participant of the secure call. In some embodiments, the data forwarder may be also the participant of the secure call, and thus is capable of receiving and transmitting secure call content.

In the method for making a secure call in a multi-party call provided by embodiments of the present disclosure, by setting up the secure service data channel with the terminals participating the secure call, content of the secure call is transmitted after encryption, so as to realize call security among the terminals participating the secure call. Compared with the existing techniques, in embodiments of the present disclosure, the secure call may be set up and content of the secure call may be encrypted, so as to guarantee call security in the multi-party call.

FIG. 6 schematically illustrates a structural diagram of a device for making a secure call in a multi-party call according to an embodiment. Referring to FIG. 6, the device may include: a setting up circuitry 11 configured to set up a secure service data channel with terminals participating the secure call; and a processing circuitry 12 configured to process service data of the terminals participating the secure call which is transmitted on the secure service data channel.

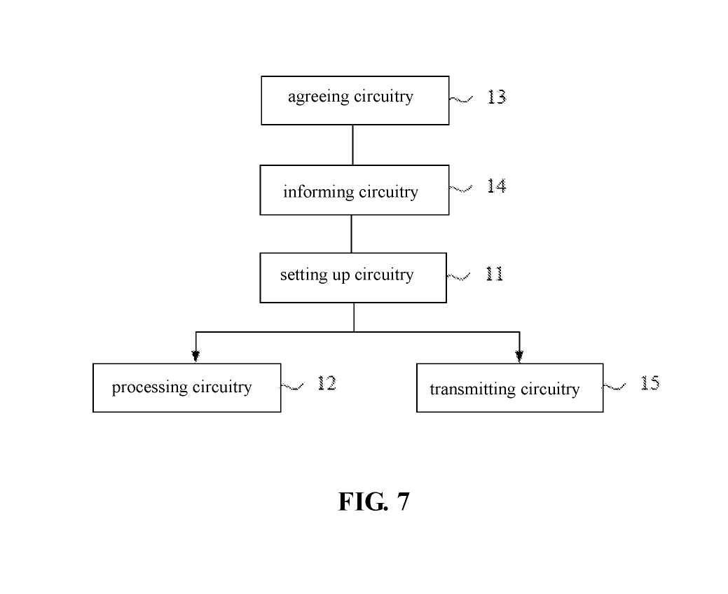

Referring to FIG. 7, in some embodiments, the device may further include an agreeing circuitry 13 configured to: before the setting up circuitry 11 sets up the secure service data channel with the terminals participating the secure call, agree security types supported by the terminals participating the secure call.

In some embodiments, the device may further include an informing circuitry 14 configured to: before the setting up circuitry 11 sets up the secure service data channel with the terminals participating the secure call, inform the terminals participating the secure call to use an agreed key.

In some embodiments, the processing circuitry 12 may be configured to: encrypt service data of the terminals participating the secure call which is transmitted on the secure service data channel; and decrypt service data of the terminals participating the secure call which is transmitted on the secure service data channel.

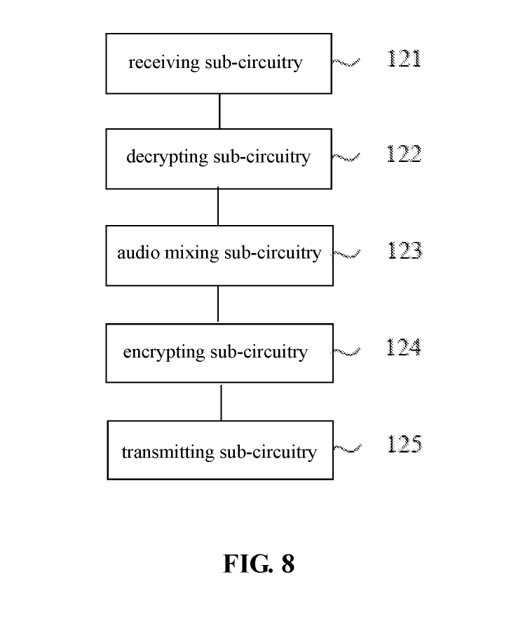

Referring to FIG. 8, in some embodiments, the processing circuitry 12 may include: a receiving sub-circuitry 121 configured to receive first encrypted service data from the terminals participating the secure call; a decrypting sub-circuitry 122 configured to decrypt the first encrypted service data to obtain decrypted service data of the terminals participating the secure call; and an audio mixing sub-circuitry 123 configured to perform audio mixing to the decrypted service data of the terminals participating the secure call except a first participant terminal, wherein the first participant terminal is any one of the terminals participating the secure call.

In some embodiments, the processing circuitry 12 may further include: an encrypting sub-circuitry 124 configured to encrypt the service data which has been subjected to the audio mixing by the audio mixing sub-circuitry 123 to obtain second encrypted service data; and a transmitting sub-circuitry 125 configured to transmit the second encrypted service data to the first participant terminal.

In some embodiments, the setting up circuitry 11 may be configured to: during a set-up process of the multi-party call, directly set up the secure service data channel with the terminals participating the secure call.

In some embodiments, the setting up circuitry 11 may be configured to: during an unencrypted multi-party call, set up the secure service data channel with the terminals participating the secure call outside a current unencrypted service data channel.

Referring to FIG. 7, in some embodiments, the device may further include a transmitting circuitry 15 configured to transmit unencrypted data from terminals which do not participate the secure call to the terminals participating the secure call via the unencrypted service data channel.

By the device for making a secure call in a multi-party call provided in embodiments of the present disclosure, by setting up the secure service data channel with the terminals participating the secure call, content of the secure call is transmitted after encryption, so as to realize call security among the terminals participating the secure call. Compared with the existing techniques, in embodiments of the present disclosure, the secure call may be set up and content of the secure call may be encrypted, so as to guarantee call security in the multi-party call.

In an embodiment of the present disclosure, a multi-pass terminal including any one of the above devices for making a secure call in a multi-party call is provided.

Those skilled in the art can understand that all of or a portion of the processes in the method provided in the above embodiments can be implemented by related hardware with instruction of computer program. The computer program may be stored in a readable storage medium, such as a magnetic disk, an optical disk, a Read-Only Memory (ROM) or a Random Access Memory (RAM).

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for making a secure call in a multi-party call, comprising:
setting up a secure service data channel with terminals participating the secure call; and
processing service data of the terminals participating the secure call which is transmitted on the secure service data channel.

2. The method according to claim 1, wherein prior to setting up a secure service data channel with terminals participating the secure call, the method further comprises:
agreeing security types supported by the terminals participating the secure call.

3. The method according to claim 1, wherein prior to setting up a secure service data channel with terminals participating the secure call, the method further comprises:
informing the terminals participating the secure call to use an agreed key.

4. The method according to claim 3, wherein processing service data of the terminals participating the secure call which is transmitted on the secure service data channel comprises:
encrypting service data of the terminals participating the secure call which is transmitted on the secure service data channel; and
decrypting service data of the terminals participating the secure call which is transmitted on the secure service data channel

5. The method according to claim 4, wherein processing service data of the terminals participating the secure call which is transmitted on the secure service data channel comprises:
receiving first encrypted service data from the terminals participating the secure call;
decrypting the first encrypted service data to obtain decrypted service data of the terminals participating the secure call; and
performing audio mixing to the decrypted service data of the terminals participating the secure call except a first participant terminal, wherein the first participant terminal is any one of the terminals participating the secure call.

6. The method according to claim 5, wherein processing service data of the terminals participating the secure call which is transmitted on the secure service data channel comprises:
encrypting the service data which has been subjected to the audio mixing to obtain second encrypted service data; and
transmitting the second encrypted service data to the first participant terminal.

7. The method according to claim 6, wherein setting up a secure service data channel with terminals participating the secure call comprises:
during a set-up process of the multi-party call, directly setting up the secure service data channel with the terminals participating the secure call.

8. The method according to claim 6, wherein setting up a secure service data channel with terminals participating the secure call comprises:
during an unencrypted multi-party call, setting up the secure service data channel with the terminals participating the secure call outside a current unencrypted service data channel.

9. The method according to claim 8, further comprising:
transmitting unencrypted data from terminals which do not participate the secure call to the terminals participating the secure call via the unencrypted service data channel.

10. A device for making a secure call in a multi-party call, comprising:
a setting up circuitry configured to set up a secure service data channel with terminals participating the secure call; and
a processing circuitry configured to process service data of the terminals participating the secure call which is transmitted on the secure service data channel.

11. The device according to claim 10, further comprising:
an agreeing circuitry configured to: before the setting up circuitry sets up the secure service data channel with the terminals participating the secure call, agree security types supported by the terminals participating the secure call.

12. The device according to claim 11, further comprising:
an informing circuitry configured to: before the setting up circuitry sets up the secure service data channel with the terminals participating the secure call, inform the terminals participating the secure call to use an agreed key.

13. The device according to claim 12, wherein the processing circuitry is configured to:
encrypt service data of the terminals participating the secure call which is transmitted on the secure service data channel; and
decrypt service data of the terminals participating the secure call which is transmitted on the secure service data channel.

14. The device according to claim 13, wherein the processing circuitry comprises:
a receiving sub-circuitry configured to receive first encrypted service data from the terminals participating the secure call;
a decrypting sub-circuitry configured to decrypt the first encrypted service data to obtain decrypted service data of the terminals participating the secure call; and
an audio mixing sub-circuitry configured to perform audio mixing to the decrypted service data of the terminals participating the secure call except a first participant terminal, wherein the first participant terminal is any one of the terminals participating the secure call.

15. The device according to claim 14, wherein the processing circuitry further comprises:
an encrypting sub-circuitry configured to encrypt the service data which has been subjected to the audio mixing by the audio mixing sub-circuitry to obtain second encrypted service data; and
a transmitting sub-circuitry configured to transmit the second encrypted service data to the first participant terminal.

16. The device according to claim 15, wherein the setting up circuitry is configured to:
during a set-up process of the multi-party call, directly set up the secure service data channel with the terminals participating the secure call.

17. The device according to claim 15, wherein the setting up circuitry is configured to:
during an unencrypted multi-party call, set up the secure service data channel with the terminals participating the secure call outside a current unencrypted service data channel.

18. The device according to claim 17, further comprising:
a transmitting circuitry configured to transmit unencrypted data from terminals which do not participate the secure call to the terminals participating the secure call via the unencrypted service data channel.

19. A multi-pass terminal comprising a device for making a secure call in a multi-party call, wherein the device comprises:
a setting up circuitry configured to set up a secure service data channel with terminals participating the secure call; and
a processing circuitry configured to process service data of the terminals participating the secure call which is transmitted on the secure service data channel.

20. The multi-pass terminal according to claim 19, wherein the device further comprises:
an agreeing circuitry configured to: before the setting up circuitry sets up the secure service data channel with the terminals participating the secure call, agree security types supported by the terminals participating the secure call.
